(19) United States
(12) Patent Application Publication
(10) Pub. No.: US 2011/0082660 A1
(43) Pub. Date: Apr. 7, 2011

(54) WEIGHING SYSTEM

(75) Inventor: Takashi Kimura, Shiga (JP)

(73) Assignee: ISHIDA CO., LTD., Kyoto (JP)

(21) Appl. No.: 12/672,246

(22) PCT Filed: Aug. 4, 2008
(86) PCT No.: PCT/JP2008/063956

§ 371 Date: Feb. 4, 2010

(30) Foreign Application Priority Data
Aug. 17, 2007 (JP) 2007-213178

(51) Int. Cl. G01G 19/393; G06F 19/00; G01G 23/01

(52) U.S. Cl. 702/101; 177/25.18

(57) ABSTRACT

A weighing system is equipped with a plurality of weighing units, a combinatorial computing section, a weight checking unit, a correction value computing section and a correction value inputting section. The weighing units weigh goods. The combinatorial computing section is configured to perform combinatorial computing of the weighing results, to select a combination of the goods that is close to a target value calculated using a correction value, and to selectively control the weighing units to discharge the goods. The weight checking section is disposed downstream of the weighing units to check weights of the goods that have been discharged from the weighing units. The correction value computing section is configured to calculate the correction value based on checking results obtained by the weight checking unit. The correction value inputting section is configured to input the correction value to the combinatorial computing section.

### CROSS-REFERENCE TO RELATED APPLICATIONS

This national phase application claims priority to Japanese Patent Application No. 2007-213178 filed on Aug. 17, 2007. The entire disclosure of Japanese Patent Application No. 2007-213178 is hereby incorporated herein by reference.

### TECHNICAL FIELD

The present invention relates to a weighing system that performs combinatorial computation of weighing results resulting from a plurality of weighing units that weigh goods, selects a combination that is close to a target value obtained by adding a correction value to a lower limit value within a predetermined weight range, and quantitatively weighs the goods.

### BACKGROUND ART

Conventionally, when quantitatively weighing goods such as potato chips, there has been employed a weighing system that distributes and supplies goods to a plurality of weighing units and weighs those goods, selects a combination that falls within a predetermined weight range by performing combinatorial computation of those weighed weights, and causes the goods to be discharged from the weighing units of that combination. In this weighing system, in order to prevent short weight of the weighed goods, the weighing system is configured to set, in a predetermined weight range defined by a lower limit value W_{L} and an upper limit value W_{U}, a target value (W_{L}+α) obtained by adding a correction value α to the lower limit value W_{L} and to select a combination that is close to this target value (W_{L}+α).

Moreover, after combination selection has been performed, before the goods of that combination are discharged, the weighing system reacquires the weighed weight from the weighing units whose combination has been selected and checks the weight value of that combination, and when the weight value falls below the lower limit value W_{L}, the weighing system halts the discharge of the goods from each of the weighing units to reliably prevent short weight. Here, when the correction value α is set large, there becomes less halting of the discharge of the goods resulting from short weight and the operating rate improves, but the average value of the combination weight becomes large overall and the yield rate deteriorates. Further, when the correction value a is set small, the yield rate improves but the operating rate deteriorates.

Thus, the applicant has proposed a technology which, in a weighing system such as described above, detects weight differences between weight values that have been combinatorially computed before and weight values that have been calculated at the time of rechecking and, on the basis of these weight differences and past weight differences, cause a correction value α that is optimum for improving the operating rate and the yield rate to be calculated (see JP-A No. 7-83742). By performing combinatorial weighing on the basis of a target value obtained by adding this correction value, the operating rate and the yield rate can be improved in real time.

### DISCLOSURE OF THE INVENTION

However, sometimes the weighing system described in JP-A No. 7-83742 cannot calculate a correction value that is suited for improving the operating rate and the yield rate because the weighing unit that is used at the time of combinatorial computation and at the time of rechecking the weight of that combination is the same. For example, when some of the weighed goods adhere to the inside of the weighing unit, the goods that are actually discharged become lighter in weight than the weight at the time of combinatorial computation, so it is necessary to set the correction value large, but because the same weighing unit is used at the time of rechecking, the fact that the goods are lightweight cannot be detected and, as a result, changing to an appropriate correction value becomes unable to be performed.

It is an object of the present invention to reliably improve the operating rate and the yield rate in a weighing system that performs combinatorial computation of weighing results resulting from a plurality of weighing units that weigh goods, selects a combination that is close to a target value obtained by adding a correction value to a lower limit value within a predetermined weight range, and quantitatively weighs the goods.

According to a first aspect of the present invention, a weighing system includes a plurality of weighing units, a combinatorial computing section, a weight checking unit, a correction value computing section and correction value inputting section. The weighing units weigh goods. The combinatorial computing section performs combinatorial computation of weighing results obtained by the weighing units. Further, the combinatorial computing section selects a combination of the goods that is close to a target value and selectively controls the weighing units to discharge the goods. The target value is a value within a predetermined weight range and calculated using a correction value. The weight checking unit is disposed downstream of the weighing units. Further, the weight checking unit checks weights of the goods that have been discharged from the weighing units. The correction value computing section calculates the correction value based on checking results obtained by the weight checking unit. The correction value inputting section inputs the calculated correction value to the combinatorial computing section.

Further, it is preferable that the correction value computing section calculates a correction value so that a predetermined operating rate and a predetermined yield rate are satisfied.

Moreover, it is preferable that the weighing system further comprises a packaging unit and a sorting unit. The packaging unit packages the goods that have been discharged from the weighing units to manufacture packaged products. The sorting unit sorts the packaged products based on the checking results obtained by the weight checking unit.

According to the aspect of the present invention, the weighing system corrects the target value of the weighed weights on the basis of the checking results obtained by the weight checking unit that is disposed separately from the weighing units that weigh the goods. For that reason, appropriate correction is performed even when the weighing values resulting from the weighing units and the weight values of the goods that are actually discharged differ because of adherence of the goods to the weighing units or the like.

### BRIEF DESCRIPTION OF THE DRAWINGS

FIG. 1 is a block diagram showing an overview of a weighing system pertaining to an embodiment; and

FIG. 2 is a diagram describing the setting of a correction value in the weighing system pertaining to the embodiment.

### BEST MODE FOR CARRYING OUT THE INVENTION

An embodiment of the present invention will be described below with reference to the drawings.

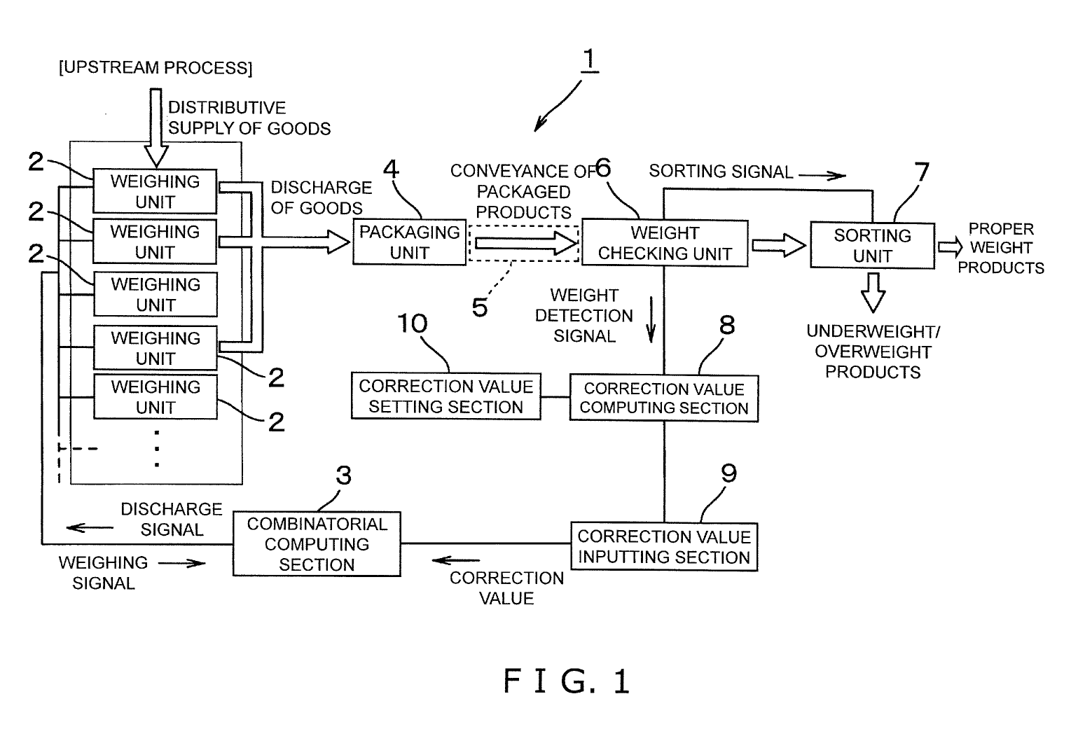

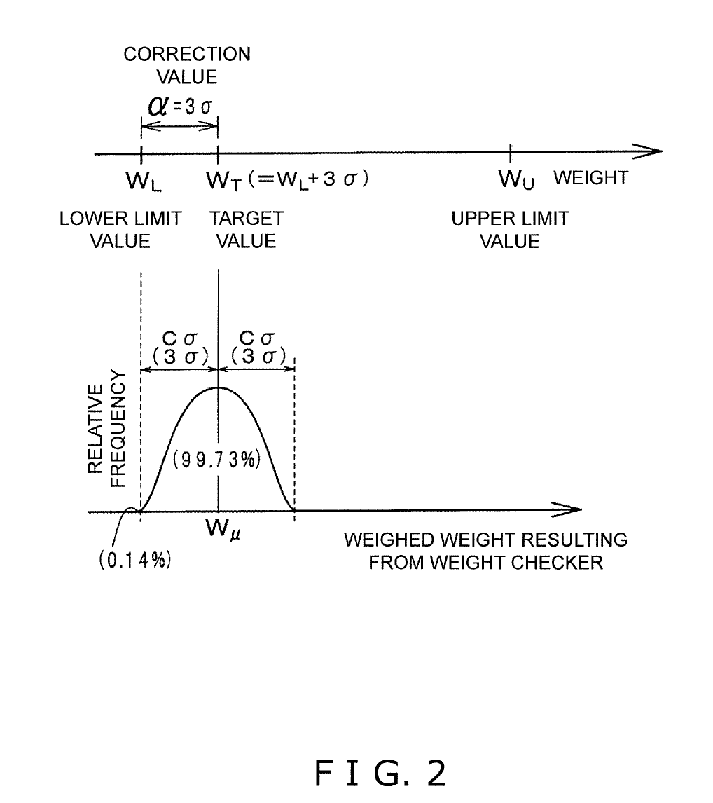

FIG. 1 is a block diagram showing an overview of a weighing system pertaining to the present embodiment, and the white arrows in this diagram represent a flow of goods and packaged products in which the goods have been packaged. FIG. 2 is a diagram describing the calculation of a correction value in the weighing system pertaining to the present embodiment.

### Weighing System 1

A weighing system 1 (FIG. 1) pertaining to the present embodiment is a system for quantitatively weighing goods G and is equipped with a plurality of weighing units 2 . . . 2, a combinatorial computing section 3, a packaging unit 4, a conveying unit 5 and a weight checking unit 6. The weighing units 2 . . . 2 weigh the goods G. The combinatorial computing section 3 performs combinatorial computation of weighing results resulting from the weighing units 2 . . . 2. Moreover, the combinatorial computing section 3 selects a combination that is close to a target value W_{T} and causes the goods G of that combination to be discharged from the corresponding weighing units 2. The target value W_{T} is a value that is within a predetermined weight range (lower limit value W_{L} to upper limit value W_{U}) and is obtained by adding a correction value α to the lower limit value W_{L} of the predetermined weight range. The packaging unit 4 packages the goods G that have been discharged from the weighing units 2 of the combination to manufacture packaged products. The conveying unit 5 conveys the packaged products P that have been packaged by the packaging unit 4. The weight checking unit 6 checks weights of the packaged products P conveyed by the conveying unit 5. It will be noted that the predetermined weight range W_{L} to W_{U} is an allowable weight range relating to content weights of the packaged products P.

Moreover, the weighing system 1 is equipped with a sorting unit 7. The sorting unit 7 sorts the packaged products P on the basis of the checking results resulting from the weight checking unit 6 into proper weight products whose content weights fall within the predetermined weight range W_{L} to W_{U} and underweight/overweight products whose content weights fall outside the predetermined weight range W_{L} to W_{U}.

Further, the weighing system 1 is equipped with correction value computing section 8 and correction value inputting section 9. The correction value computing section 8 calculates the correction value α on the basis of checking results resulting from the weight checking unit 6. The correction value inputting section 9 inputs the correction value a that has been calculated by the correction value computing section 8 to the combinatorial computing section 3. Thus, the weighing system 1 always corrects the target value W_{T}.

Moreover, the weighing system 1 is equipped with a correction value setting section 10. The correction value setting section 10 is configured such that it can set a desired operating rate and yield rate. Moreover, the correction value setting section 10 transmits an instruction signal to the correction value computing section 8 to cause the correction value computing section 8 to calculate a correction value that satisfies the set operating rate and yield rate.

### Weighing Units 2

The weighing units 2 are weighing hoppers equipped with weight sensors. The weighing units 2 weigh the weights of the goods G that have been received from an upper opening and output weight signals. Moreover, the weighing units 2 open doors closing off lower openings and discharge the goods G on the basis of discharge signals from the combinatorial computing section 3. The weighing units 2 are plurally disposed, and goods such as snack confectionery conveyed from an upstream process are distributed and supplied to each of the weighing units 2.

### Combinatorial Computing Section 3

The combinatorial computing section 3 performs combinatorial computation of the weight signals that are outputted from the weighing units 2 and selects a combination of the goods G whose total weight is closest to the target value W_{T}. The target weight W_{T} is, as mentioned above, a value that falls within the predetermined weight range W_{L} to W_{U} and is obtained by adding the correction value α to the lower limit value W_{L}. The correction value α is calculated by the correction value computing section 8 and is inputted and set by the correction value inputting section 9. Further, the combinatorial computing section 3 outputs, with respect to the weighing unit 2 whose combination has been selected, a discharge signal for causing that weighing unit to discharge the goods G that the weighing unit is holding. It will be noted that, when there is no combination that falls within the predetermined weight range W_{L} to W_{U}, the goods G within the weighing units 2 are forcibly discharged as an erroneous cycle. For this reason, quantitative weighing is temporarily stopped and the operating rate drops.

### Packaging Unit 4

The packaging unit 4 is a bag-making and packaging machine. The packaging unit 4 seals lower end portions and side portions of films formed into tubes to form bags. Moreover, the packaging unit 4 places into the bags the goods G whose combination has been selected and which have been discharged from the weighing units 2. Finally, the packaging unit 4 seals upper end portions of the films. Thus, the packaging unit 4 manufactures the packaged products P in which the goods G have been packaged.

### Conveying Unit 5

The conveying unit 5 is a belt conveyor. The conveying unit 5 receives the packaged products P that have been manufactured by the packaging unit 4. Further, the conveying unit 5 conveys the packaged products P to the weight checking unit 6. The weight checking unit 6 is disposed downstream of the weighing units 2 and the packaging unit 4. It will be noted that a chute through which the packaged products P slide and drop from above to below may also be employed instead of a belt conveyor.

### Weight Checking Unit 6

The weight checking unit 6 is a weight checker such as a scale. The weight checking unit 6 is disposed downstream of the weighing units 2. Further, the weight checking unit 6 weighs the weights of the goods G (more specifically, the packaged products P) that have been discharged from the weighing units 2 to determine the appropriateness of those weights. Specifically, whether or not the content weights obtained by subtracting the weight of the packaging material (tare weight) from the packaged products P fall within the aforementioned predetermined weight range W_{L} to W_{U} is checked. The checking results of the weight checking unit 6 are outputted as sorting signals with respect to the sorting unit 7, and weight detection signals are outputted to the correction value computing section 8.

### Sorting Unit 7

The sorting unit 7 sorts the packaged products P that are discharged from the weight checking unit 6 into the proper weight products and the underweight/overweight products on the basis of the checking results resulting from the weight checking unit 6. The proper weight products are conveyed to a downstream process where box packing and the like are performed, and the underweight/overweight products are discharged to the outside of the production process.

### Correction Value Computing Section 8

The correction value computing section 8 calculates a correction value α that satisfies a predetermined operating rate and yield rate on the basis of the checking results resulting from the weight checking unit 6, that is, the weight detection signals, to determine a target value W_{T} (=W_{L}+α) of the combination selection resulting from the combinatorial computing section 3. The calculation of the correction value α by the correction value computing section 8 is performed as follows. First, the correction value computing section 8 calculates weighing differences δ between weighed weight values W_{X} resulting from the weight checking unit 6 and an average weight value W_{μ} of the packaged products P that have been weighed up until then. Moreover, on the basis of the weighing differences δ and a variance σ² of the weighing difference distribution up until then, the correction value computing section 8 calculates a new variance σ². Then, the correction value computing section 8 calculates Cσ, as a new correction value α, which is obtained by multiplying a standard deviation σ by C times (C: constant). The standard deviation is obtained from the new variance σ². And the correction value computing section 8 outputs the new correction value α to the correction value inputting section 9.

### Correction Value Inputting Section 9

The correction value inputting section 9 sets and inputs, with respect to the combinatorial computing section 3, the correction value α that has been calculated by the correction value computing section 8. Thus, W_{L}+α obtained by adding the correction value α to the lower limit value W_{L} becomes the target value W_{T} in the combinatorial computation.

### Correction Value Setting Section 10

The correction value setting section 10 makes it possible for an operator to set a predetermined operating rate and yield rate. Further, the correction value setting section 10 transmits an instruction signal with respect to the correction value computing section 8 such that the correction value computing section 8 calculates a correction value a that can achieve the set predetermined operating rate and yield rate.

### Operation of Weighing System 1

Combinatorial weighing, packaging and weight-checking of the goods G by the weighing system 1 will be described. First, the goods G conveyed from the upstream process are distributed and supplied to the weighing units 2, and each of the weighing units 2 performs weight weighing. Next, the combinatorial computing section 3 to which those weighing signals have been transmitted selects a combination that is close to the target value W_{T}. The target value W_{T} falls within the predetermined weight range W_{L} to W_{U} and is obtained by adding the correction value α to the lower limit value W_{L}. Then the combinatorial computing section 3 transmits a discharge signal to the weighing units 2 of that combination. The weighing units 2 corresponding to that combination discharge the goods G that are being held in response to the discharge signal. The packaging unit 4 collectively packages the discharged goods G to manufacture the packaged products P.

The packaged products P are conveyed downstream by the conveying unit 5 and are carried to the weight checking unit 6. The weight checking unit 6 weighs the weights of the packaged products P and transmits those weight detection signals to the correction value computing section 8. Further, the weight checking unit 6 checks whether or not the content weights of the packaged products P fall within the predetermined weight range W_{L} to W_{U} and outputs sorting signals corresponding to those checking results. The sorting unit 7 conveys the proper weight products whose content weights fall within the predetermined weight range W_{L} to W_{U} to the downstream process in response to the sorting signals and discharges underweight/overweight products whose content weights fall outside the predetermined weight range W_{L} to W_{U} to the outside of the process. The correction value computing section 8 calculates the correction value α on the basis of the received weight detection signals. The correction value inputting section 9 sets the correction value α with respect to the combinatorial computing section 3.

### Calculation of Correction Value α

When the weighing differences δ have a normal distribution as shown in the lower portion of FIG. 2, the percentage of weighing data included within the range of W_{μ}±Cσ whose median value is the average weight value W_{μ} is theoretically unequivocally determined. For example, when C=3, the percentage of weighing data theoretically included within the range of W_{μ}±3σ becomes 99.73%. Consequently, as shown in the upper portion of FIG. 2, when the target value W_{T} (=W_{L}+3σ) is set as the correction value α=3σ, the combinatorial weighing value becomes less than the lower limit value W_{L}, the percentage of the goods G that are forcibly discharged becomes about 0.14% (≈(100−99.73)÷2), and the operating rate becomes 99.86%. Conversely, by setting the operating rate beforehand, the constant C is unequivocally determined from the normal distribution curve and the correction value α (=Cσ) corresponding thereto becomes automatically calculated.

Further, by setting the yield rate (=W_{L}÷(W_{L}+Cσ)×100) beforehand, the constant C is unequivocally determined and the correction value α becomes automatically calculated in accordance therewith. Because it is as described above, by setting a predetermined operating rate and yield rate beforehand in the correction value setting section 10, the correction value α that achieves the predetermined operating rate and yield rate can be calculated. For example, when the average unit weight of the goods G that are supplied from the upstream process fluctuates, usually the standard deviation σ also fluctuates (e.g., when the average unit weight becomes larger, usually the standard deviation σ also becomes larger), but the constant is also changed in accordance therewith and the appropriate correction value α is determined.

Incidentally, when the goods G are a sticky substance, such as food boiled in soy sauce, and adhere to the weighing unit 2, there is a tendency for the weight value of the goods G that are actually discharged from the weighing units 2 whose combination has been selected to naturally become smaller than the weighing values resulting from the combinatorial computing section 3. However, in the present weighing system 1, the correction value α is calculated on the basis of the checking results of the weight checking unit 6 that is disposed downstream of the weighing units 2, so a situation where goods that have been combinatorially computed within the predetermined weight range W_{L} to W_{U} become short weight (underweight products) as packaged products is prevented. In other words, even when, due to circumstances such as the characteristics of the goods G, a difference arises between the weighing values resulting from the combinatorial computing section 3 and the weighing values of the goods that have actually been discharged or packaged, the appropriate correction value α is calculated without being affected thereby, and it is not necessary to administer any kind of special processing with respect thereto.

### Characteristics of Weighing System 1 Pertaining to Embodiment

Because it is as described above, the weighing system 1 pertaining to the embodiment has the following characteristics.

First, the weighing system 1 pertaining to the embodiment performs quantitative weighing with the weighing units 2 and the combinatorial computing section 3. The combinatorial computing section 3 performs combinatorial computation of the weighing results resulting from the weighing units 2, selects a combination that is closest to the target value W_{T} that is within the predetermined weight range W_{L} to W_{U} and that is obtained by adding the correction value α to the lower limit value W_{L}, and selectively controls the weighing units 2 to discharge the goods. Further, the weighing system 1 has the characteristic that it is equipped with the weight checking unit 6, the correction value computing section 8 and the correction value inputting section 9. The weight checking unit 6 is disposed downstream of the weighing units 2 and checks the weights of the goods G that have been discharged from the weighing units 2 of that combination. The correction value computing section 8 calculates the correction value α on the basis of the checking results resulting from the weight checking unit 6. The correction value inputting section 9 inputs the correction value α to the combinatorial computing section 3.

The weighing system 1 corrects the target value W_{T} of the quantitative weighing on the basis of the checking results of the weight checking unit 6 that is located downstream of the weighing units 2 for performing quantitative weighing, so even when the weighing values resulting from the weighing units 2 and the weight values of the goods G that have actually been discharged from the weighing units 2 differ due to the affect of adherence of the goods to the weighing units 2 or the like, appropriate correction is performed and a substantive drop in the operating rate is avoided.

Second, the correction value computing section 8 has the characteristic that it calculates the correction value α that satisfies the predetermined operating rate and yield rate in accordance with the setting from the correction value setting section 10. Consequently, when a high operating rate must be ensured such as when product shipments are being rushed, or when a higher yield rate must be ensured even when, conversely, the operating rate deteriorates somewhat, production efficiency matching the circumstances at those times can be improved.

Third, the weighing system 1 pertaining to the embodiment has the characteristic that it is equipped with the packaging unit 4 and the sorting unit 7. The packaging unit 4 packages the goods G that are discharged from the weighing units 2 to manufacture the packaged products P. The sorting unit 7 sorts the packaged products P on the basis of the checking results of the weight checking unit 6. The weighing system 1 performs weight checking after packaging, so shipments of underweight products or overweight products resulting from circumstances arising between combinatorial computation and packaging are reliably prevented. Further, the weight checking unit 6 is used for performing sorting according to the weights of the packaged products and is not disposed with dedicated means for correction value calculation, so system costs are inexpensive.

In addition to the above, the weighing system of the present invention is not limited to the embodiment, and various changes may be made thereto in a range that does not depart from the gist of the present invention.

1. A weighing system comprising:
a plurality of weighing units configured and arranged to weigh goods;
a combinatorial computing section configured to perform combinatorial computation of weighing results obtained by the weighing units, to select a combination of the goods that is close to a target value which is a value within a predetermined weight range and calculated using a correction value, and to selectively control the weighing units to discharge the goods;
a weight checking unit disposed downstream of the weighing units to check weights of the goods that have been discharged from the weighing units;
a correction value computing section configured to calculate the correction value based on checking results obtained by the weight checking unit; and
a correction value inputting section configured to input the calculated correction value to the combinatorial computing section.

2. The weighing system according to claim 1, wherein
the correction value computing section is further configured to calculate the correction value so that a predetermined operating rate and a predetermined yield rate are satisfied.

3. The weighing system according to claim 1, further comprising
a packaging unit configured and arranged to package the goods that have been discharged from the weighing units to manufacture packaged products and
a sorting unit configured and arranged to sort the packaged products based on the checking results obtained by the weight checking unit.

4. The weighing system according to claim 1, wherein
the combinatorial computing section is configured to obtain the target value by adding the correction value to a lower limit value of the predetermined weight range.
